(19) United States
(12) Patent Application Publication
(10) Pub. No.: US 2013/0075475 A1
(43) Pub. Date: Mar. 28, 2013

(54) PERSONAL SECURE MULTI-IDENTIFICATION DEVICE

(71) Applicants: Jason Dean HART, Freemont, CA (US); Louise HART, Fremont, CA (US)

(72) Inventors: Jason Dean HART, Freemont, CA (US); Louise HART, Fremont, CA (US)

(21) Appl. No.: 13/462,173

(22) Filed: May 2, 2012

(30) Foreign Application Priority Data
May 2, 2011 (AU) 2011901616

(51) Int. Cl. G06K 19/077

(52) U.S. Cl. CPC G06K 19/07707
USPC 235/492

(57) ABSTRACT

A multi-identification device is described, comprising at least one antenna, a microprocessor, a memory, and an electronic display. At least one set of identification data is stored in the memory and displayed on the electronic display based on information received by the at least one antenna and processed by the microprocessor.

### PRIORITY

This application claims priority to Australian Patent Application No. 2011901616, entitled “Personal Secure Multi-Identification Device,” filed May 2, 2011, the entirety of which is incorporated herein by reference.

### FIELD OF THE INVENTION

The present invention relates to identification means. More particularly, it concerns a personal secure multi-identification device capable of presenting multiple identity cards relating to an individual.

### DESCRIPTION OF THE RELATED ART

More and more identity cards, such as smartcards and building access cards, along with other personal cards, such as credit cards and membership cards, are being produced and issued to individuals.

An individual may have multiple identification cards confirming their eligibility to gain access to secure locations, or operate machinery or vehicles, for example. Further, individuals may have multiple credit cards as well as frequent shopper cards. An excessive amount of identity cards and other personal cards can be burdensome on individuals, and can result in a significant expense where such cards are frequently replaced.

Additionally, and perhaps more importantly, an environmental cost must be considered in the production and destruction of so many cards. Generally, identity cards are made from a cheap form of plastic called polyvinyl chloride (PVC). PVC is not biodegradable and emits potentially harmful greenhouse gases when burned/destroyed.

Despite the above, PVC is generally considered the best material for identity cards, as it is cost-effective and suitably robust to withstand frequent handling.

The present invention advantageously provides an alternative to existing identity and personal cards. The invention according to certain embodiments may advantageously be used to reduce the number of identity and personal cards carried by an individual, and therefore reduce the impact such cards have on the environment, while maintaining a high level of security.

### SUMMARY OF THE INVENTION

According to a first aspect of the invention, there is provided a multi-identification device, comprising at least one antenna, a microprocessor, a memory, and an electronic display. At least one set of identification data is stored in the memory and displayed on the electronic display based on information received by the at least one antenna and processed by the microprocessor.

According to another aspect of the invention, there is provided a method for displaying multiple sets of identification data on a device. The method comprises the steps of providing a device having an electronic display, at least one antenna, a memory, and a microprocessor. Multiple sets of identification data are stored in the memory, and at least one set of identification data is retrieved from the memory and displayed based on information received by the at least one antenna and processed by the microprocessor.

In accordance with a further aspect of the invention, there is provided a multi-identification device, comprising a user interface module, a microprocessor, a memory, and an electronic display. At least one set of identification data is stored in the memory and displayed on the electronic display based on information received by the user interface module and processed by the microprocessor.

According to another aspect of the invention, there is provided a multi-identification device, comprising an electronic display, a user interface module, a secure memory, at least one antenna, and at least one microprocessor. At least one identity card, selected from a plurality of identity cards stored on the secure memory, is displayed on the electronic display in response to a user providing identification information into the user interface module and processed by the at least one microprocessor; and/or data received by the at least one antenna and processed by the at least one microprocessor.

In accordance with yet a further aspect of the invention, there is provided a multi-identification device, comprising an electronic display and a memory. At least one set of user identification data is retrieved from memory and displayed on the electronic display.

Further aspects of the invention will be seen variously. The at least one antenna is tuned to approximately 125 kHz and/or 13.56 MHz and/or approximately 890 MHz (including a long range vicinity transponder). Further, the electronic display is an electronic paper (electronic ink) display requiring no power to maintain its last display state.

In accordance with a further aspect, the microprocessor includes encryption modules to emulate a PKI smartcard. Additionally, the memory is encrypted by a secure processor, and the at least one set of identification data stored in the memory is displayed on the electronic display based also on information provided by a user/holder of the device. Information provided by a user/holder of the device includes biometric information and/or a personal identification number (PIN). The device can be detected and transmit secure information over a distance of more than one meter.

The device in accordance with a further aspect of the invention comprises a battery.

### BRIEF DESCRIPTION OF THE DRAWINGS

The invention will now be described in a non-limiting manner with respect to a preferred embodiment in which:

FIG. 1 is an overview of a preferred embodiment of the device of the present invention; and

FIG. 2 is a further overview of a preferred embodiment of the components of the present invention.

### DETAILED DESCRIPTION OF PREFERRED EMBODIMENTS

In the following discussion and in the claims, the terms “including”, “includes”, “comprises” and “comprising” are used, and are to be read, in an open-ended fashion, and should be interpreted to mean “including, but not limited to . . . ”.

Further, in the following discussion and the claims that follow, the term “identity card” is to be given a broad meaning and may refer to any personal card, for example but not limited to, smartcards, proximity/vicinity cards, credit/debit cards, membership cards, frequent shopper cards, and identification cards (such as a driver's licence).

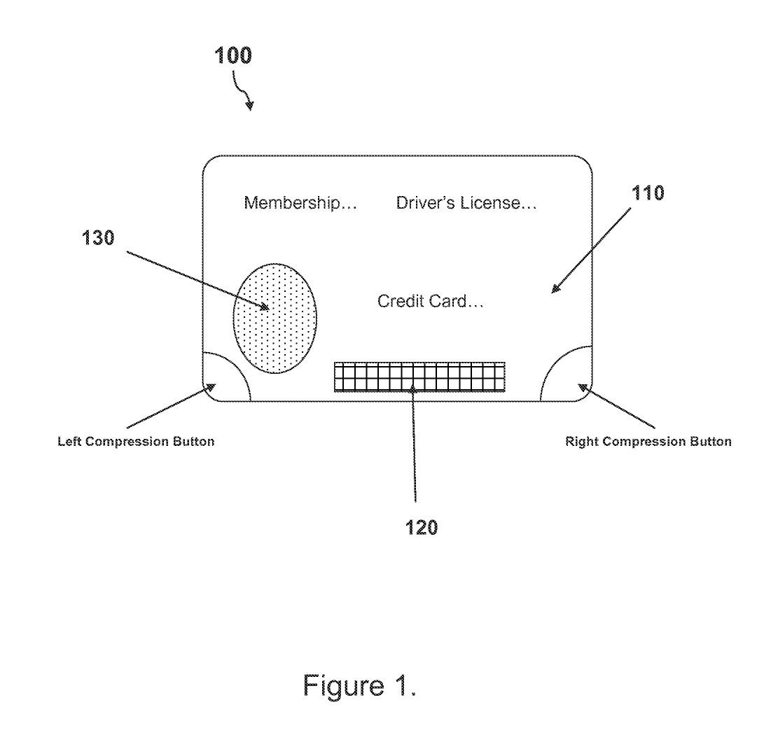

Referring to FIG. 1, a multi-identification device 100 in accordance with a preferred embodiment of the present invention is shown. The device preferably has the dimensions of a CR-80 identity card (approximately 3.4 inches wide (86.36 mm), 2.15 inches long (54.61 mm) and 0.030 inches thick (0.762 mm)). Other dimensions and formats may be used, such as the CR-100 format. However, the CR-80 format is preferred as the dimensions allow a flexible card that may be conveniently stored in a user's wallet, for example.

It will be appreciated that the thickness of the device 100 may vary depending on the on-board components and desired functionality. Such variations will become apparent to a skilled person upon reading this specification.

The device 100 is preferably made of polyvinyl chloride (PVC). It will be appreciated that alternative materials may be used in the construction of the device that provide similar rigidity and flexibility as PVC.

In accordance with a particularly preferred embodiment of the present invention, the device houses an electronic display 110. The electronic display 110 is preferably located on one side of the device 100, spanning the full length of the surface of the side. It will be appreciated that the display may not span the full length of the device, but be of a suitable surface area to display identification data or an identity card in a readable or visible manner. Further, the display may be present only on one side of the device, or alternatively be present on both sides of the device.

The electronic display is preferably an electronic paper (electronic ink) display. However, it will be appreciated that the display could also be a light emitting diode (LED) display or a liquid crystal display (LCD), or other suitable display.

An electronic paper (electronic ink) display is the preferred medium for the electronic display as electronic ink is capable of holding text and images for prolonged periods of time without drawing power. Accordingly, in a particularly preferred embodiment of the present invention, identification data or an identity card, such as a driver's license, credit card or membership card, can be statically displayed on the device 100, while allowing the information displayed to be changed in accordance with a user's desire or in response to the surrounding environment.

The device 100 further includes a user interface module 120 to allow the user/holder of the device to determine which set of identification data or identity card is to be displayed on the electronic display. The user interface module 120 may be a menu for the user to choose which identity card to display from the plurality of identity cards stored on the device. Preferably, the user interface module is a key pad to receive a personal identification number (PIN), or is a biometric reader to receive biometric information from the user/holder of the device, such as a fingerprint.

The device 100 further includes at least one antenna 130 to facilitate the exchange of data from the device 100 to the surrounding environment. It will be appreciated that the exchange of data may be facilitated by a number of mediums, such as a universal serial bus (USB) port, or optical communications. However, in an embodiment of the present invention, the at least one antenna 130 is employed to facilitate 14443 contactless communications and RFID communication, and allows credit card processing, while conforming to NIST and ISO standards. Accordingly, the device of the present invention can be used to replace a smartcard, Europay, MasterCard and VISA (EMV) credit card, cashless payment system, and numerous identity cards.

Preferably, the at least one antenna 130 is a high gain antenna allowing for power to be received at the device 100. Power may be supplied by coupling to a card reader (not shown), when the device is placed into the reader's field, or may be supplied by induction when the device is placed on or into a suitable card holder (not shown) with inductive properties.

The at least one antenna 130 is preferably capacitively loaded using resonant coupling to form tuned LC circuits in order to receive power. It will be appreciated that other antenna configurations may be employed in order to receive a suitable amount of power to drive the electronic display and other on-board components.

It is to be noted that the device 100 preferably does not include an on-board power supply. Suitable power is drawn from the surrounding environment such as through electromagnetic field coupling or induction, as described above. However, it will be appreciated that a small power supply, such as a battery, could be incorporated into the device 100 to assist with intensive device applications.

The at least one antenna 130 is also used to receive location information. Location information relates to the surrounding environment of the device 100 and may be used to determine the identity card or set of identification data to be displayed on the electronic display. It will be appreciated that the location information may also be used to determine which set of identification data or identity is not to be displayed, or is to be removed (blanked) from the display in accordance with derived security protocol.

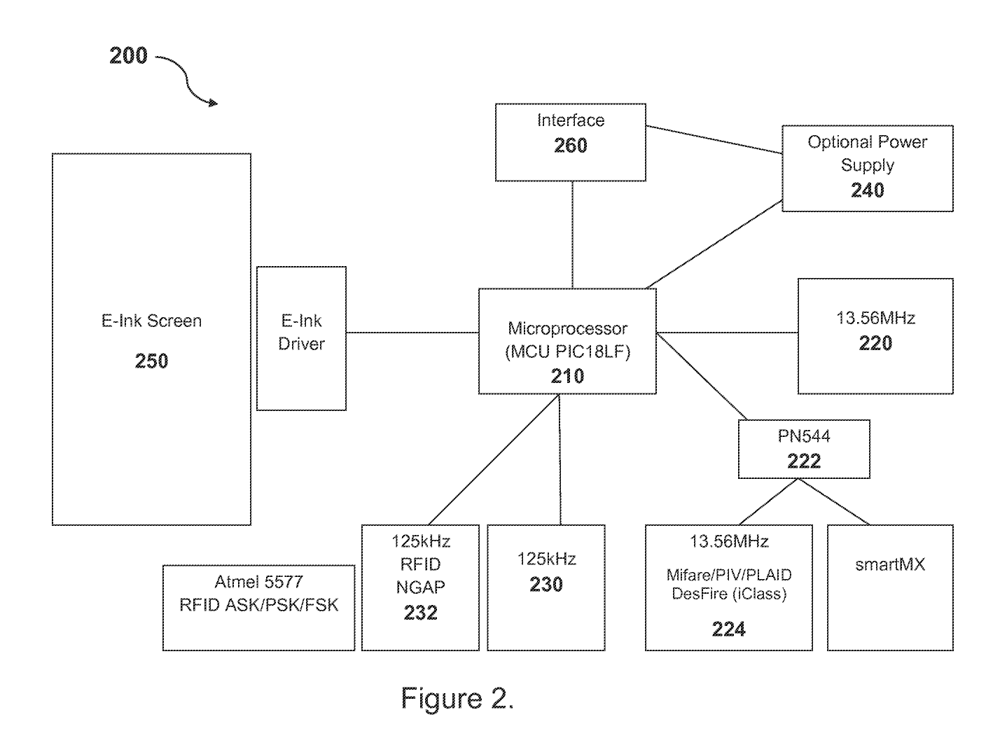

Turning now to FIG. 2, preferred on-board components of the device 200 are shown. Microprocessor 210 coordinates communication as well as the delivery of power to the device, and selects or determines which set of identification data or which identity card is to be displayed on the electronic display in accordance with defined security protocol.

As discussed above, power is preferably delivered to the device using radio field inductive technology or other short-range communication technology capable of communicating via electromagnetic field induction. At least one antenna 220 and 230 receives the current and powers the microprocessor.

This aspect of the invention increases the lifetime of the device and is environmentally-friendly as the need for a traditional battery that is susceptible to dispersing heat, and requires specific disposal steps, is diminished.

An optional power supply 240 may also be employed delivering power to the microprocessor to allow functionality to the device.

The at least one antenna 220 and 230 is also used to receive location information. The location information is then delivered to the microprocessor to determine which set of identification data or which identity card is to be displayed on the electronic display 250.

Additionally, the at least one antenna 220 and 230 may be tuned to particular operation frequencies to allow the device to operate as a smartcard, RFID tag, proximity card or other ISO 14443 compliant device. In a particularly preferred embodiment, the at least one antenna 220 and 230 is tuned to 13.56 MHz and 125 kHz respectively. It will be appreciated that operating at 13.56 MHz will allow the device to emulate numerous formats such as NFC, MIFARE & SmartMX, CSN, IS015693, DesFire, and PKI through a suitable controller 222, such as a PN 544, communicating with the microprocessor 210. Additional formats to upgrade the device may be provided by Java applets downloaded to the microprocessor.

An additional embodiment of the invention contains a vicinity GEN2 RFID compatibility, including a long range vicinity transponder operating in the 890 MHz frequency range, allowing for the detection of the device at distances that can exceed 3 meters.

Operation at 125 kHz will allow the device to emulate a RFID proximity card for use in building security. Preferably, the device is able to emulate programmable technology (for example, Atmel 5577 format), allowing security access to multiple buildings.

Secure elements 232 and 224 are dedicated cryptographic processors that perform encryption and authentication functions. The secure elements 232 and 224 temporarily store PKI keys and certificates relating to the device. The secure element controls security and PKI authentication by assigning and managing security attributes. Secure elements 232 and 224 also include a dedicated secure memory to store sets of identification data and identity cards for display on the electronic display 250. Additional memory (secured or unsecured) may also be included in the on-board components to satisfy storage requirements of large amounts of identification data.

Once authentication is complete (as required), the microprocessor 210 communicates with the memory to retrieve the relevant set of identification data and identity card for display on the electronic display 250.

Additional physical security components may be incorporated onto the device. For example, in a preferred embodiment of the invention the device includes an interface module 260 such as a key pad for the insertion of a user's personal identification number (PIN). The device will not function and the antenna will not be activated (i.e. the device will be unable to receive or transmit data) until the user/holder of the device has been verified through the interface module 260. An audible alarm may sound from the device if a user is not verified within a predetermined number of PIN entry attempts. In an alternative embodiment, the interface module 260 may include biometric sensors that are incorporated to retrieve biometric information, such as a fingerprint, from the user/holder of the card for verification.

It will be appreciated that the device and methods of the present invention will have a broad range of use. As mentioned above, standard identity or credit cards are printed for finite use with a view to disposal in a relatively short period of time. The replacement of such cards becomes a significant expense when the cards are routinely disposed of. More importantly, there is a substantial cost on the environment due to the increased production (and then destruction) of such cards.

The present invention provides a personal secure multi-identification device that can change both its electronic and visual appearance depending upon the identity context required by the user or the surrounding environment. Multiple sets of identification data and identity cards can be stored on the device and displayed as appropriate. The present invention provides a ‘green’ alternative to existing identity cards whilst providing digital and visual security.

The following is a hypothetical situation demonstrating the numerous advantages of the present invention.

A user required to wear their smart identity card enters a place of employment. The personal secure multi-identification device of the present invention displays the user's photograph, title, name and other identifying information on the electronic display. The user electronically communicates with a door reader using contactless or visual scan technology (such as a barcode displayed on the electronic display) and physical access is determined.

The user touches the personal secure multi-identification device against a contact or contactless reader attached to a computer, and the device performs the PKI functions required to authenticate the person to access information technology resources.

The user leaves their place of work and the personal secure multi-identification device senses it has left the relevant building. The device optionally blanks the electronic display or reverts to an identity card selected by the user.

The user enters a second place of employment and the personal secure multi-identification device changes its electronic display to the secondary employer's or contractor's identity card.

If the user enters an area they are not authorized to enter, the personal secure multi-identification device could optionally flash and transmit an audible and electronic warning.

The personal secure multi-identification device may also be used in a cashless payment environment. For example, where a user has multiple credit cards, individual credit identification data can be downloaded into the device and visually displayed when used for payment. Accordingly, the present invention allows both visual and electronic validation for payment.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

Some embodiments described herein relate to a computer storage product with a computer- or processor-readable medium having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

1. A multi-identification device, comprising:
at least one antenna;
a microprocessor;
a memory; and
an electronic display,
wherein at least one set of identification data is stored in the memory and displayed on the electronic display based on information received by the at least one antenna and processed by the microprocessor.

2. The device of claim 1, wherein the at least one antenna is tuned to a frequency of at least one of approximately 125 kHz, approximately 13.56 MHz, or approximately 890 MHz.

3. The device of claim 1, wherein the electronic display is an electronic paper display requiring no power to maintain its last display state.

4. The device of claim 1, wherein the microprocessor includes encryption modules to emulate a PKI smartcard.

5. The device of claim 1, wherein the memory is encrypted by a secure processor.

6. The device of claim 1, wherein the at least one set of identification data stored in the memory is displayed on the electronic display based also on information provided by a user of the device.

7. The device of claim 6, wherein information provided by the user of the device includes at least one of biometric information or a personal identification number (PIN).

8. The device of claim 1, wherein the device further comprises a battery.

9. The device of claim 2, further comprising a long range vicinity transponder operating in the 890 MHz range.

10. The device of claim 1, wherein the device can be detected and transmit information over a distance of more than 1 meter.

11. The device of claim 1, wherein the device is in the format of a CR-80 identity card.

12. A method for displaying multiple sets of identification data on a device, comprising:
providing a device having an electronic display, at least one antenna, a memory, and a microprocessor;
storing multiple sets of identification data in the memory;
retrieving at least one set of identification data from the memory, and
displaying the data based on information received by the at least one antenna and processed by the microprocessor.

13. The method of claim 12, wherein the at least one antenna is tuned to a frequency of at least one of approximately 125 kHz, approximately 13.56 MHz or approximately 890 MHz.

14. The method of claim 12, wherein the electronic display is an electronic paper display.

15. The method of claim 12, wherein the microprocessor includes encryption modules to emulate a PKI smartcard.

16. The method of claim 12, wherein the memory is encrypted by a secure processor.

17. The method of claim 12, wherein the at least one set of identification data stored in the memory is displayed on the electronic display based also on information provided by a user of the device.

18-22. (canceled)

23. A multi-identification device, comprising:
a user interface module;
a microprocessor;
a memory; and
an electronic display,
wherein at least one set of identification data is stored in the memory and displayed on the electronic display based on information received by the user interface module and processed by the microprocessor.

24. The device of claim 23, wherein information provided by a user of the device includes at least one of biometric information or a personal identification number (PIN).

25. The device of claim 23, wherein the electronic display is an electronic paper display.

26. The device of claim 23, wherein the microprocessor includes encryption modules to emulate a PKI smartcard.

27. The device of claim 23, wherein the memory is encrypted by a secure processor.

28. The device of claim 23, the device further comprising at least one antenna, and wherein at least one set of identification data stored in the memory is displayed on the electronic display based also on information received by the at least one antenna and processed by the microprocessor.

29-31. (canceled)

32. A multi-identification device, comprising:
an electronic display;
a user interface module;
a secure memory;
at least one antenna; and
at least one microprocessor,
wherein at least one identity card, selected from a plurality of identity cards stored on the secure memory, is displayed on the electronic display in response to at least one of:
a user providing identification information into the user interface module and processed by the at least one microprocessor; or
data received by the at least one antenna and processed by the at least one microprocessor.

33. The device of claim 32, wherein the at least one antenna is tuned to a frequency of at least one of approximately 125 kHz, approximately 13.56 MHz or approximately 890 MHz.

34. The device of claim 32, wherein the electronic display is an electronic paper display.

35. (canceled)

36. The device of claim 32, wherein the memory is encrypted by a secure processor.

37-38. (canceled)

39. The device of claim 33, further comprising a long range vicinity transponder operating in the 890 MHz range.

40. The device of claim 32, wherein the device can be detected and transmit information over a distance of more than 1 meter.

41. (canceled)

42. A multi-identification device, comprising an electronic display and a memory, wherein at least one set of user identification data is retrieved from memory and displayed on the electronic display.
